(19) United States
(12) Patent Application Publication
(10) Pub. No.: US 2012/0059664 A1
(43) Pub. Date: Mar. 8, 2012

(54) SYSTEM AND METHOD FOR MANAGEMENT OF PERSONAL HEALTH AND WELLNESS

(76) Inventors: Emil Markov Georgiev, Hartland, WI (US); Lionel Wodecki, Maisons Alfort (FR); Erik Kemper, Franklin, WI (US); Zhiye Lu, Pudong Shanghai (CN); Tao Sun, Hongkou district (CN)

(21) Appl. No.: 12/876,328

(22) Filed: Sep. 7, 2010

(51) Int. Cl. G06Q 50/00; G06T 11/20

(52) U.S. Cl. 705/2; 345/440

(57) ABSTRACT

A system and method for management of personal health and wellness is disclosed. The system receives an input for generating a user profile for a user, with the user profile having an initial health status goal associated therewith including target physiological parameter levels, nutritional uptake, and physical fitness activity. Physiological data, nutritional data, and physical fitness data are received by the system over a period of time on measured physiological parameters, dietary consumption, and physical activity of the user, with the system then analyzing and comparing the received data to the physiological parameters, nutritional uptake, and physical fitness activity associated with the initial health status goal. The system communicates to the user a personalized health and wellness status update that is based on the analysis of the received data and the comparison of such data to the physiological, nutritional, and physical activity metrics associated with the initial health status goal.

### BACKGROUND OF THE INVENTION

The present invention relates generally to automated systems and methods for health and wellness management. More specifically, the present invention relates to an automated system and method for capturing and tracking health and wellness data and for home management of health and wellness via analysis and sharing of the data.

Traditionally, the healthcare system has been focused on responding to already occurring health events like illness, chronic condition onset, injury, etc. In more recent times, this reactive model of health care has been mitigated by putting more emphasis into illness and injury prevention. Initially, the focus on prevention has been directed toward medical screening for early detection of illness and on identification of individuals who may be at-risk for a particular condition, based on an assessment of risk factors/predisposition to certain illnesses, such as via genetic screening. For example, apparatus and methods for at-home patient monitoring have been developed for purposes of monitoring various physiological parameters such as heart rate, blood pressure, weight, and blood oxygen levels. The acquired parameters can then be transmitted to a processing unit for subsequent analysis, with feedback being provided to a healthcare provider to allow for early detection of an illness.

While at-home patient monitoring of various physiological parameters provides early indication of a potential illness, the monitoring of physiological parameters by itself is limiting in providing an overall picture of the health and wellness of the patient and fails to provide recommendations or guidelines for improving patient health. That is, it is acknowledged today that lifestyle choices like nutrition, physical activity and fitness, etc., also play a significant role in the overall health and wellness of an individual. Moreover, for a number of chronic conditions (e.g., diabetes), the ability to adhere to recommended lifestyles choices in terms of nutrition and physical fitness plays a substantial role in maintaining their quality of life and keeping their chronic conditions under control. Currently however, consumers do not have adequate resources that allow them to manage all aspects of their health and wellness outside of clinical environments, including nutrition, fitness/physical activity levels as well as in home medical & vitals measurement (i.e., measurement of physiological parameters).

Therefore, a need exists for a system and method that integrates into a single easy to use and understand personalized health and wellness management system, capabilities for capturing and tracking health and wellness data that encompasses each of physiological data, nutritional data, and physical activity data for a patient. A need also exists for such a health and wellness management system to manage, analyze, and share such data with qualified health professionals, such that recommendations can be provided to a patient to empower the patient to proactively manage their own health and wellness.

### BRIEF DESCRIPTION OF THE INVENTION

Embodiments of the invention provide an automated system and method for capturing and tracking health and wellness data of a user and for home management of health and wellness via analysis and sharing of the data with the user, such that the user can manage those aspects of their health and wellness over which they have individual control.

In accordance with one aspect of the invention, a non-transitory computer readable storage medium has stored thereon a computer program comprising instructions, which, when executed by a computer, cause the computer to receive an input for generating a user profile for a user of interest, with the user profile having an initial health status goal associated therewith including target physiological parameter levels, nutritional uptake, and physical fitness activity. The instructions also cause the computer to receive physiological data, nutritional data, and physical fitness data for the user of interest over a period of time that are directed respectively to a plurality of measured physiological parameters, dietary consumption, and physical activity of the user of interest, and to analyze each of the physiological data, nutritional data, and physical fitness data. The instructions further cause the computer to compare each of the physiological data, nutritional data, and physical fitness data to the physiological parameters, nutritional uptake, and physical fitness activity associated with the initial health status goal and communicate to the user of interest a personalized health and wellness status update based on the analyzed physiological data, nutritional data, and physical fitness data, and on the comparison of such data to the physiological parameter levels, nutritional uptake, and physical fitness activity associated with the initial health status goal.

In accordance with another aspect of the invention, a method for managing health and wellness for a user of interest includes the steps of generating a user profile for a user of interest on a health and wellness management system in response to a user input and establishing initial health and wellness goals for the user of interest and tied to the user profile, with the initial health and wellness goals having associated therewith target physiological parameter levels, nutritional uptake levels, and physical fitness activity levels. The method also includes the steps of acquiring and tracking physiological data, nutritional uptake data, and physical fitness activity data for the user of interest over a period of time by way of the health and wellness management system and analyzing each of the physiological data, nutritional uptake data, and physical fitness activity data using the health and wellness management system to determine at least one of: a trend in user health and wellness, compliance with the physiological parameter levels, nutritional uptake levels, and physical fitness activity levels associated with the initial health and wellness goals, and a correlation between the nutritional uptake levels, physical fitness activity levels, and acquired physiological data. The method further includes the step of communicating to the user of interest a personalized health and wellness status update based on the analysis of the physiological data, nutritional uptake data, and physical fitness activity data.

In accordance with yet another aspect of the invention, a health and wellness management system includes a display screen configured to display health and wellness data to a user and a processor. The processor is programmed to formulate an initial health and wellness goal specific to a user of interest that includes target physiological parameter, nutritional uptake, and physical activity levels, automatically receive data on physiological parameters, dietary consumption, and physical activity for the user of interest from a plurality of enabled devices over a period of time, and analyze the data for each of the received physiological parameters, dietary consumption, and physical activity. The processor is further programmed to generate a personalized health dashboard on the display screen illustrative of the analyzed data on the physiological parameters, dietary consumption, and physical activity, with the personalized health dashboard displaying at least one of a trend chart of user physiological parameters, nutritional uptake, and physical activity levels, compliance with the initial health and wellness goal, and recommendations for the user of interest regarding nutritional uptake and physical fitness activity levels for meeting the initial health and wellness goal.

These and other advantages and features will be more readily understood from the following detailed description of preferred embodiments of the invention that is provided in connection with the accompanying drawings.

### BRIEF DESCRIPTION OF THE DRAWINGS

The drawings illustrate embodiments presently contemplated for carrying out the invention.

In the drawings:

FIG. 1 is a schematic block diagram of a health and wellness management system according to an embodiment of the present invention.

FIG. 2 is personalized health dashboard display generated by the health and wellness management system of FIG. 1 according to an embodiment of the present invention.

FIG. 3 is a flowchart illustrating a computer implemented technique for capturing, tracking, and managing health and wellness of a patient of interest according to an embodiment of the present invention.

FIG. 4 is a block diagram illustrating an example of implementing the health and wellness management system of FIG. 1 for managing a patient with type-II diabetes according to an embodiment of the present invention.

FIG. 5 is a block diagram illustrating an example of implementing the health and wellness management system of FIG. 1 for managing a college athlete according to an embodiment of the present invention.

### DETAILED DESCRIPTION

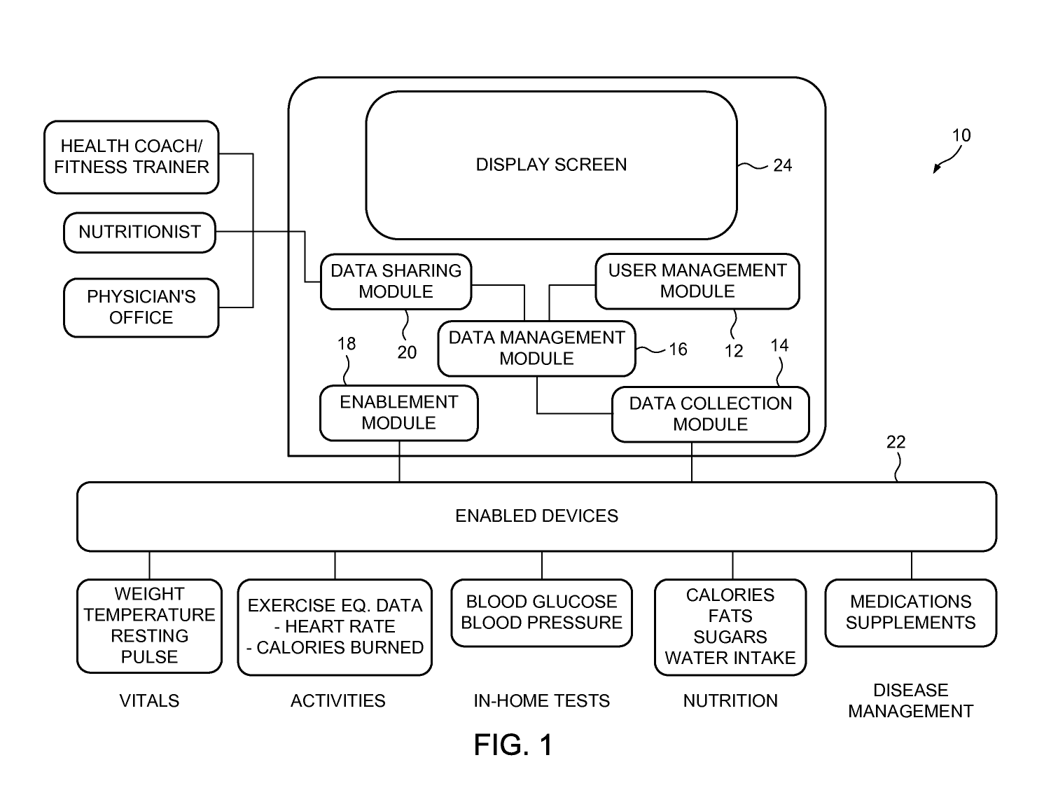

Referring to FIG. 1, a health and wellness management system 10 is illustrated according to an embodiment of the invention. Health and wellness management system 10 is designed to provide a holistic model of a user's health by empowering a user to manage their health and wellness through a single access point that brings into focus all health related aspects over which the user has direct control, including nutrition, fitness and physical activities, and home medical and vitals testing. The health and wellness management system 10 also provides means to utilize the ability to capture and track these health and lifestyle data as a way for the user to communicate with their health and wellness advisors, such as personal physicians and other clinicians, fitness experts, nutritionists, and lifestyle coaches, in order to set health and wellness goals and get better personalized guidance.

According to embodiments of the invention, health and wellness management system 10 may be in the form of a dedicated device or a computer or web-based program. If the health and wellness management system 10 is in the form of a dedicated device, such a device would be configured to have memory and processing capabilities for storing and analyzing data and also be configured to connect to the internet, such as through a wireless connection provided by a wi-fi network or cellular based network. Similarly, if health and wellness management system 10 is in the form of a program stored on a laptop computer, the laptop computer would provide memory and processing capabilities for storing and analyzing data and also for connecting to the internet. In another embodiment, health and wellness management system 10 would be stored on a remotely located central server, such that the system 10 is accessible via the internet by way of a computer or other web-capable portable device, such as a PDA or iPhone®, for example.

Referring still to FIG. 1, in each of the embodiments set forth above, health and wellness management system 10 is provided with a computer readable storage medium or processor 11 that includes therein a plurality of modules 12, 14, 16, 18, 20. Modules 12, 14, 16, 18, 20 perform data acquisition, storage, processing, and sharing functions such that health and wellness management system 10 operates as a single access point that manages and monitors all health related aspects of a user. Modules 12, 14, 16, 18, 20 also thus provide for tracking and sharing this health and lifestyle data as to determine progress toward specific health and wellness goals and to communicate such progress with other health and wellness advisors.

Included in the plurality of modules is a user management module 12 that provides for setting-up of one or more user profiles on the health and wellness management system 10 that correspond to individual users of the system. The creation of user profiles by user management module 12 allows health and wellness management system 10 to operate as a multi-user system that can monitor the health and wellness of separate users. In creating a user profile for a user, user management module 12 can also set up access credentials to allow or deny access to profiles, such as via password protection or encryption, such that an individual's health and wellness data is protected in a multi-user system.

In setting up an individualized profile for a user based on health and wellness data specific to the user, user management module 12 works in conjunction with a data collection module 14 and data management module 16. That is, in generating a user profile, user management module 12 receives initial input data via the data collection module 14 that identifies unique characteristics of a user, with the data management module 16 then making use of this information to provide personalized health information for generating the user profile. The specific information received by data collection module 14 may include information on the user's past health history (i.e., illnesses, surgeries, chronic disease), family history, a review of current symptoms and/or health-related behaviors, and current medications and supplements. The information may also include current measurement of various physiological parameters. Thus, for example, data collection module 14 may receive data regarding the user's current weight, height, and blood pressure, which are indicative of a current health status.

According to embodiments of the invention, the health related data received by data collection module 14 can be entered manually by a user or provided automatically by way of an enabled health monitoring device associated or registered with health and wellness management system 10. For entering data manually into the data collection module 14, it is recognized that a data entry screen can be provided on a display of health and wellness management system 10 (e.g., a display on the dedicated device, computer, or mobile device), with data being entered via a keyboard text entry, responding to questions provided on the display, or by clicking through dialog/dropdown menus provided on the display.

For purposes of entering data automatically to data collection module 14, an enabled device configuration and management module 18 (i.e., “enablement module”) is provided in health and wellness management system 10. The enablement module 18 provides for registration of various health monitoring devices 22 with health and wellness management system 10, such that data can be transferred from the devices 22 to data collection module 14. A physical connection, such as a serial connection or USB port, can be implemented for data transfer between the various health monitoring devices and health and wellness management system 10 (i.e., to the dedicated device/computer), or also by way of wireless transmission such as infrared or RF transmission.

Upon receipt of health and wellness data for a specified user by data collection module 14, data management module 16 analyzes the acquired information to provide personalized health information for the user profile generated by user management module 12. That is, a user profile is generated that provides the user with a summary of his or her existing health condition.

In addition to providing data to user management module 12 for generating the user profile, data management module 16 also generates initial health and wellness related goals for the individual user that can be based, in part, on data gathered in generating the user profile. That is, data management module 16 analyzes initial health and lifestyle data for purposes of identifying health related areas the user may need to address in order to maximize the likelihood that they will implement and maintain a healthy lifestyle. A plan and/or set of goals may be provided in the form of a suggested healthy daily routine, for example. The suggested healthy daily routine may include any combination of specific suggestions for incorporating proper nutrition, exercise, medications, and selected activities of daily living in the user's life. Schedules may be offered as guides for how these suggested activities can be incorporated into the user's life.

As further input for generating the initial health and wellness goal(s), recommendations or input may be provided by qualified health professionals, such as a physician, health coach or fitness trainer, and nutritionist. Such qualified health professionals can provide a separate analysis of the initial health and wellness data acquired on the user for purposes of identifying health related areas the user may need to address in order to implement and maintain a healthy lifestyle, set athletic performance goals, etc.

Upon generation of the user profile and goals associated with the user profile, health and wellness management system 10 operates to monitor a user's health and wellness over a period of time. In operation, health and wellness management system 10 periodically acquires health and wellness data from the user via manual input from the user or automatically from one of a plurality of enabled health monitoring devices or sensors 22.

As set forth above, for automatically acquiring data, a plurality of devices or sensors 22 can be enabled and linked to health and wellness management system 10 (via enablement module 18) to provide data indicative of various physiological parameters or an activity level of an individual. Devices 22 enabled and linked to health and wellness management system 10 may include any number and type of devices that provide physiological and physical activity data, such as a scale, blood pressure measurement device, pulse oxymeter, treadmill, elliptical, bike, or running monitoring device, for example. The physiological and physical activity data can thus include, for example, the user's weight, heart rate, pulse rate, beat-to-beat heart variability, EKG or ECG, respiration rate, core body temperature, blood pressure, body fat, hydration level, activity level, oxygen consumption, and glucose or blood sugar level. According to an exemplary embodiment of the invention, enablement module 18 provides for enabled devices 22 to transmit data to data collection module 14 using a common transmittable data format with no (or very minimal) actions required by the users, i.e., passive data collection.

According to an exemplary embodiment of the invention, the various modules 12, 14, 16, 18 of health and wellness management system 10 work in conjunction with enabled devices 22 to provide for multi-user use of the enabled devices 22 and authentication of data transmitted from the enabled devices 22 to the health and wellness management system 10 to tie the received data to a particular user. For example, the enabled devices 22 may be configured to receive a user ID from a user registered with the health and wellness management system 10 (i.e., a user having a user profile stored on user management module 12). Once a user has authenticated their identity with the enabled device(s), the device can acquire data on the user directed to one of a physiological parameter, physical activity, or nutritional uptake, and then transmit that data to the data collection module 14. An authentication tag is embedded in the transmitted data to verify that the data was acquired from a specified user, such that data management module 16 can tie the received data to a specific user profile and perform analysis on the data. The authentication procedures set forth above enabled by modules 12, 14, 16, 18 of health and wellness management system 10 and enabled devices 22 thus allow for the enabled devices 22 to be employed by multiple users, with the data being identifiable by the enabled devices and the modules 12, 14, 16, 18 to tie acquired/received data to a specific user.

In addition to collecting data by automatically receiving data from enabled devices 22 as described above, the user can also periodically provide data manually to health and wellness management system 10 that relates to various life activities. User can enter such data directly to health and wellness management system 10, whether the system is in the form of a dedicated device, a program stored on a computer, or a web accessible program stored on a remote server. According to one embodiment, an individual user could access a web site maintained by a central server and can directly input information to health and wellness management system 10 by entering text freely, by responding to questions posed by the web site, or by clicking through dialog boxes provided by the web site. Such manually entered data could include physiological data, physical activity data, and nutritional data.

As an example of physical activity and physiological data that could be entered into health and wellness management system 10, blood pressure could be measured by an enabled device 22 and automatically entered into health and wellness management system 10. Additionally, data from enabled exercise equipment (e.g., treadmill) could automatically transmit data to health and wellness management 10 that includes information on physical activity parameters such as respiration rate, calories burned, max measured heart rate, and duration of physical activity. While such physical activity and physiological data can be entered into health and wellness management system 10 automatically via enabled devices, it is also recognized that physical activity and physiological data can also be manually input by the user. Data input by the user may include other details regarding the user's daily activities that cannot be transmitted via an enabled device 22, such as various manual labor tasks that contribute to the user's overall physical activity level.

As an example of nutritional information that could be entered into health and wellness management system 10, the amount and types of foods consumed throughout the course of a day could be entered by a user. The user could enter the type of foods consumed throughout the course of a day, such as bread, pasta, cereal, rice, fruit, vegetables, fish, meat, poultry, dry beans, eggs, nuts, milk, yogurt, cheese, and water. The user could also enter the number of servings of each type of food consumed throughout the course of a day. According to one embodiment, an enabled nutrition source/device 22 could provide nutritional data and/or portion size from restaurant menus, packaged meals, or bottled beverages, that could facilitate tracking of nutritional content and quantities of the user's meals.

The data management module 16 is programmed to summarize and analyze the data received from devices 22 and entered manually by the user to provide useable information in assessing the user's health and wellness condition. With respect to physical activity data received by health and wellness management system 10, for example, the data management module 16 can be programmed to calculate an average, minimum or maximum heart rate or respiration rate over a defined period of time. Data management module 16 can derive information relating to an individual's physiological state based on the data indicative of one or more physiological parameters, with the data management module 16 being programmed to derive such information using known methods based on the data indicative of one or more physiological parameters. With respect to nutritional information data received by health and wellness management system 10, the data management module 16 can be programmed to summarize and analyze the data to determine daily calorie intake, protein intake, fiber intake, fat intake, carbohydrate intake, and/or water consumption,

Upon receiving physiological data, physical activity data, and nutritional data via enabled devices 22 and manual input from the user, data management module 16 analyzes such information to provide a user with an indication of their recent performance with respect to achieving certain performance metrics associated with the initially set health and wellness goals. As one output of the analysis of the physiological data, physical activity data, and nutritional data, data management module 16 provides trends of the user's health and wellness over a defined period of time. That is, for each of a plurality of physiological parameters, as well as for physical activities and nutritional uptake, data management module 16 provides a past history of values, such that trends can be identified for various aspects of the user's health and wellness.

Analysis of the received physiological data, physical activity data, and nutritional data by data management module 16 also allows for a determination as to whether certain target parameters are being met as outlined in the health and wellness goals for the user. Data management module 16 can determine if certain metrics related to physiological parameters, physical activity, and nutritional intake are in accordance with recommended levels set forth in the user goals. For example, data management module 16 can determine, with respect to a suggested healthy activity level, whether a recommended aerobic exercise level for a day has been reached or if a recommended target number of calories have been burned for a day, either through the aerobic exercise and/or another lifestyle activity. Similar determinations may be made by data management module 16 with respect to whether a measured physiological parameter is at a desired level (e.g., glucose level) or whether dietary consumption for a day is accordance with recommended guidelines regarding caloric intake and/or various nutritional levels (e.g., fiber intake, water intake, sugar intake, etc.)

Analysis of the received physiological data, physical activity data, and nutritional data by data management module 16 further provides for correlations to be made between the different data types. For example, analysis of the received physiological data, physical activity data, and nutritional data by data management module 16 may indicate that the user's mood may be tied to the user's weight level and sleeping pattern. Based on this identified correlation, the data management module 16 may further provide feedback or recommendations to the user regarding changes to the user's physical activity level, dietary consumption, or present medications. Using the current example, data management module 16 may recommend that the increase their sleep levels and manage their dietary consumption to promote improved their mood and overall health and wellness.

By analyzing received data on physiological parameters, physical activity, and nutritional intake, data management module 16 is able to generate a personalized health and wellness status for the user and communicate this health and wellness status to the user. According to embodiments of the invention, data management module 16 can communicate the personalized health and wellness status to the user via any one of numerous mediums and in any one of numerous forms that include varying amounts of data and analysis. That is, the personalized health and wellness status can be communicated to the user via various sensory means. For example, an audible alert could be generated by data management module 16 when a measured physiological parameter is determined to fall outside of an acceptable pre-determined threshold range or as a reminder for the user to perform a certain activity (e.g., take medication, check blood pressure, etc.), such as data management module 16 causing an audible alert to be generated from a dedicated health and wellness management device or from a user's mobile device. Alternatively, a visual display can be provided to the user displaying: trends in the received physiological data, physical activity data, and nutritional data; compliance with the initial health and wellness goals; and/or recommendations regarding behavioral changes. Alternatively, a tactile actuator could signal a user that an event is about to occur or has occurred in order for them to act according to their own desired behavior.

According to an exemplary embodiment of the invention, data management module 16 is configured to generate a personalized health dashboard for the health and wellness management system 10 that can provide the feedback to the user. This feedback may encompass the data trends, compliance with the initial health and wellness goals, and recommendations regarding behavioral changes. The health dashboard can be displayed on a display screen 24 of health and wellness management system 10 (e.g., a display screen of a dedicated device or a computer display) for purposes of informing the user of their present health and wellness status and their progress toward achieving the goals set forth by the health and wellness management system 10.

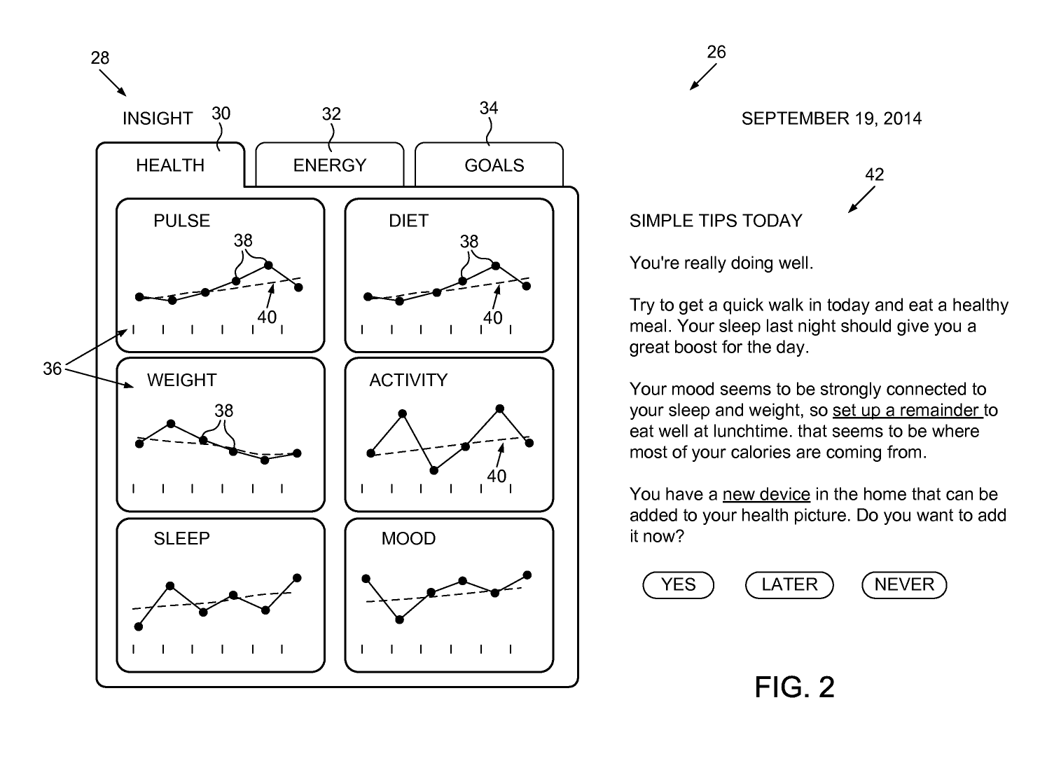

An exemplary personalized health dashboard 26 is shown in FIG. 2 according to an embodiment of the invention. The health dashboard 26 provides various types and forms of data to the user that is generated from the data acquired by health and wellness management system 10, with the data being indicative of physiological parameters, physical activity, and nutritional information, as well as calculated health, wellness and lifestyle indicators derived from the physiological parameters, physical activity, and nutritional information. For example, based on data input by the user relating to the foods he or she has eaten, things such as calories and amounts of proteins, fats, carbohydrates, and certain vitamins can be calculated. As another example, heart rate, pulse rate, respiration rate, core temperature, blood pressure, and oxygen consumption can be used to provide indicators to the user of his or her physiological condition.

For displaying the various types and forms of data, a plurality of graphical and textual utilities are located on the health dashboard that provide feedback to a user regarding their performance and the degree to which they have succeeded in reaching a healthy daily routine suggested by health and wellness management system 10. According to the embodiment of FIG. 2, measured metrics for physiological parameters, physical activity, and dietary consumption can be graphically displayed to the user via a graphics area 28. A plurality of tabs 30, 32, 34 are provided for graphics area 28 to control the specific type of data shown to the user, such as a health tab 30, energy tab 32, and goals tab 34. As shown in FIG. 2, when health tab 30 is selected, a plurality of graphs 36 can be provided for displaying various physiological parameters, physical activity, and dietary consumption, with the graphs having numerical values associated therewith to identify specific measurements/values for received data. While graphs 36 are displayed as a linear-type tracking of data, other suitable graphs/charts could also be used, such as bar graphs or pie charts, for example. Graphs 36 display a plurality of distinct data points 38 corresponding to individual measurements of a parameter. According to one embodiment, health dashboard 26 enables users to control the graphs 36 to display physiological parameters, physical activity, and dietary consumption for a user selectable time interval, such as for a past 24 hrs, past week, etc.

According to an embodiment of the invention, graphs 36 also indicate and display trends in data by way of a trend line 40 that is included therein. For each measured physiological parameter, trend shifts can be detected using a known statistical analysis, with these trends being illustrated by lines 40. Additionally, a trend in user behavior, such as physical activity or dietary consumption, can also be identified via trend lines 40. The displaying of multiple graphs 36 for a plurality of parameters also allows for a user to visualize a correlation between nutritional uptake and physical activity and the measured physiological parameters. The user can thus see the impact of nutritional uptake and physical activity on measured physiological parameters, such as weight, mood, blood pressure, etc.

In addition to graphics area 28, a text area 42 is also provided on health dashboard 26. The text area 42 is a textual display that illustrates identified correlations between certain user activities and certain measured physiological parameters and suggests changes or updates to the user's behavior, such as changes to physical fitness activity, dietary consumption, medication levels, and so forth. As shown in FIG. 2, for example, based on an identified correlation between the user's weight and sleeping patterns and the user's mood, the data management module 16 may provide feedback or recommendations to the user regarding changes to the user's daily and physical activity levels and dietary consumption. That is, text area 42 displays a recommendation for the user to increase their sleep levels and manage their dietary consumption to promote an improved mood and overall health and wellness and for setting up a reminder to make such changes to their daily routine.

According to an embodiment of the invention, text area 42 can also provide information on any potential updates to the health and wellness management system 10. For example, text area 42 can indicate that a new device has been obtained by the user for monitoring a physiological parameter, for example. Text area 42 can then facilitate registering or enablement of the device with the health and wellness management system 10 by asking the user if such enablement is desired.

While health tab 30 displays user data of measured physiological parameters, physical activity, and dietary consumption, energy tab 32 may display information directed to general levels of energy experienced by the user over a period of time. Energy tab 32 may also display information such as calories consumed, calories burned, activity levels, sleep amounts, or any other factors contributing to the user's overall sense of energy level. It is recognized that graphs for certain physiological parameters, physical activity, and dietary consumption may be displayed on multiple tabs.

With respect to goals tab 34, data may be displayed to the user illustrating a relationship between the measured physiological parameters, physical activity, and dietary consumption and the recommended levels for correlating physiological parameters, physical activity, and dietary consumption set forth by the user goals set forth by the health and wellness management system 10. The comparison between the measured and target goal levels of physiological parameters, physical fitness activity, and nutritional uptake allows the consumer to efficiently track their performance with respect to meeting the pre-set health and wellness goals. The user can thus visualize which daily activities may need to be altered in order to meet the target goals, whether it be nutrition uptake, physical activity, or another daily activity.

Along with displaying data to the individual user, health and wellness management system 10 is also configured to share health and wellness data of the patient with various healthcare providers, health coaches, or physical trainers associated with the user. Referring again to FIG. 1, a data sharing module 20 is included in health and wellness management system 10 for providing such data sharing between the user and specified individuals. Once data has been received and analyzed by data management module 16, it may be compressed and encrypted by data sharing module 20 according to any one of a variety of well known methods and then sent out over a local or global electronic network, preferably the Internet, directly to specified individuals (e.g., via email) or uploaded to a central server that is accessible by the specified individuals. The sharing of health and wellness data related to the user in a timely manner with desired individuals allows for those individuals to review the user's performance with respect to meeting their health and wellness goals, diagnose any potentially unhealthy physiological measurements or trends detected by health and wellness management system 10, or recommend changes to the user's physical activity level, dietary consumption, or present medications.

According to one embodiment, data sharing module 20 is configured to set-up and manage individual profiles of third-party recipients associated with the patient of interest with whom the user wishes to share data. As shown in FIG. 1, for example, data sharing module 20 may set up profiles for a physician's office, health coach or fitness trainer, and nutritionist. Data sharing module 20 then generates summary reports directed to the physiological data, nutritional data, and physical activity data received for the user and shares the summary reports with the desired third-party recipients by way of the profiles associated therewith. The summary reports can be shared with the third-party recipients by a variety of methods, including email, log in by the third-party recipient to a password protected website, or via a secure encrypted data transmission.

The health and wellness data provided via the summary reports may be useful in numerous ways. Transmission of the summary report to the user's physician, for example, allows the physician to examine the health and wellness data to monitor for a chronic disease of the patient or facilitate early detection of a potential medical condition, for example. Transmission of the summary report to the user's health coach/fitness trainer allows the health coach/fitness trainer to monitor the user's physical activity level, set up a personalized exercise program, and track the user's following of such an exercise program, for example. Transmission of the summary report to the user's nutritionist allows the nutritionist to examine the health and wellness data to monitor the user's daily dietary consumption, set target nutritional levels for the user, and plan daily meals for the user that meet such target nutritional levels, for example.

Such recommendations by the third party recipients can be implemented as feedback by health and wellness management system 10. That is, feedback from various third party recipients can be transmitted back to health and wellness management system 10 via data acquisition module 14, whereby data management module 16 can function to update the initial health and wellness goals based on the feedback. At least one of the target physiological parameter levels, nutritional uptake, and physical fitness activity level associated with the initial health and wellness goals can be altered based on the third-party feedback, such that revised health and wellness goals can be formulated.

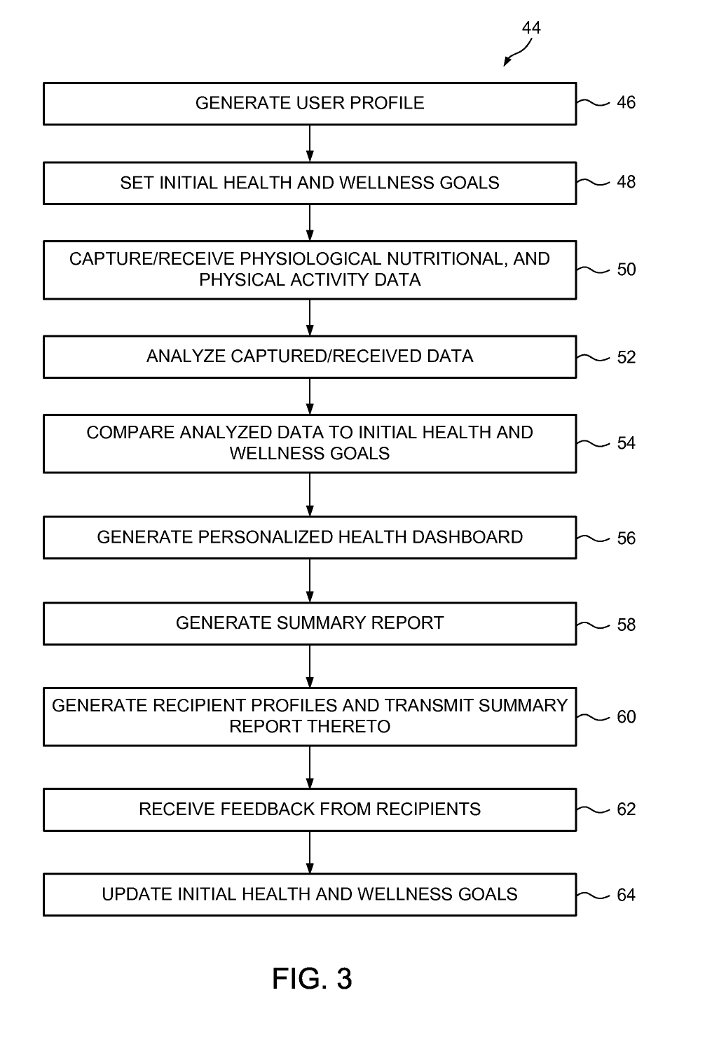

Referring now to FIG. 3, a technique 44 for capturing and tracking health and wellness data and for home management of health and wellness via analysis and sharing of the data that can be implemented by health and wellness management system 10 is shown. The technique 44 begins at STEP 46 where a user profile is generated for the user (i.e., the patient of interest) by way of the health and wellness management system. The user profile can be set up based on patient specific data entered into the health and wellness management system, such as via health and wellness data manually entered by the user or by initial data acquisitions from an enabled device. Upon generation of the user profile, initial health and wellness goals are established for the user at STEP 48 that are tied to the user profile, with the initial health and wellness goals having associated therewith target physiological parameter levels, nutritional uptake levels, and physical fitness activity levels specified for the user. The initial health and wellness goals can be derived from input from one or more health professionals associated with the user (e.g., physician, fitness trainer, nutritionist, etc.) and can also be derived in part from an analysis of the user baseline data entered into the health and wellness management system during creation of the user profile.

After the initial health and wellness goals are set, health and wellness data is captured or received by the health and wellness management system over a period of time at STEP 50, such that physiological parameter levels, nutritional uptake levels, and physical fitness activity levels can be monitored and tracked. Physiological data, nutritional data, and physical fitness data for the user can be captured by a plurality of enabled devices/sensors registered with the health and wellness management system or can be entered manually into the system by the user. The physiological data, nutritional data, and physical fitness data received by the health and wellness management system provide information on the physiological parameter levels, nutritional uptake levels, and physical fitness activity levels of the user, with such information being analyzed at STEP 52 to provide a fuller picture of the user's current health. That is, trends in the user's health and wellness, as well as a correlation between nutritional uptake levels, physical fitness activity levels, and acquired physiological data can be determined based on an analysis of the received data. A comparison between the received physiological data, nutritional data, and physical activity data and the physiological parameter levels, nutritional uptake levels, and physical fitness activity levels associated with the initial health and wellness goals is then performed at STEP 54 to determine the user's success in complying with the metrics set forth in the initial health and wellness goals.

The analysis and comparison(s) performed at STEPS 52 and 54 provides for a personalized visual health dashboard display to be generated by the health and wellness management system at STEP 56. The personalized health dashboard can be displayed to the user via a display screen on a dedicated device or on a separate computer or mobile device display screen, depending on the embodiment of the health and wellness management system. The personalized health dashboard provides to the user at least one of a graphical display, a textual display, and a numerical display illustrative of the analyzed physiological data, nutritional uptake data, and physical fitness activity data. For example, graphical displays can illustrate a trending in physiological parameters, nutritional uptake, or physical activity for the patient, and textual displays can provide recommendations for the patient of interest regarding nutritional uptake and physical fitness activity levels for meeting the initial health and wellness goals.

Upon the analysis and comparison(s) performed at STEPS 52 and 54, the health and wellness management system also generates a summary report at STEP 58 that is illustrative of trends in the user's health and wellness, correlation between nutritional uptake levels, physical fitness activity levels, and acquired physiological data, and the user's success in complying with the metrics set forth in the initial health and wellness goals. The summary report provides a concise picture of the user's health and wellness that can be shared with qualified health professionals associated with the user, such as physicians, personal fitness trainers, nutritionists, and life coaches. Thus, in STEP 60, the health and wellness management system generates profiles for targeted third-party recipients of the summary report and transmits the summary report to each targeted recipient.

Upon receipt of such a summary report, it is recognized that the user's physician, personal fitness trainer, and/or nutritionist may judge that changes may be desired in the user's initial health and wellness goals. As such, at STEP 62, the health and wellness management system receives feedback from the physician, personal fitness trainer, and/or nutritionist that provides instructions on any desired changes to the user's initial health and wellness goals. The health and wellness management system analyzes such feedback and, responsive thereto, determines updated health and wellness goals at STEP 64 reflective of the changes/updates to the initial health and wellness goals suggested by the health personnel. The updated health and wellness goals are then maintained in the health and wellness management system and are provided to the user to better help empower to proactively manage their own health and wellness at an optimum level.

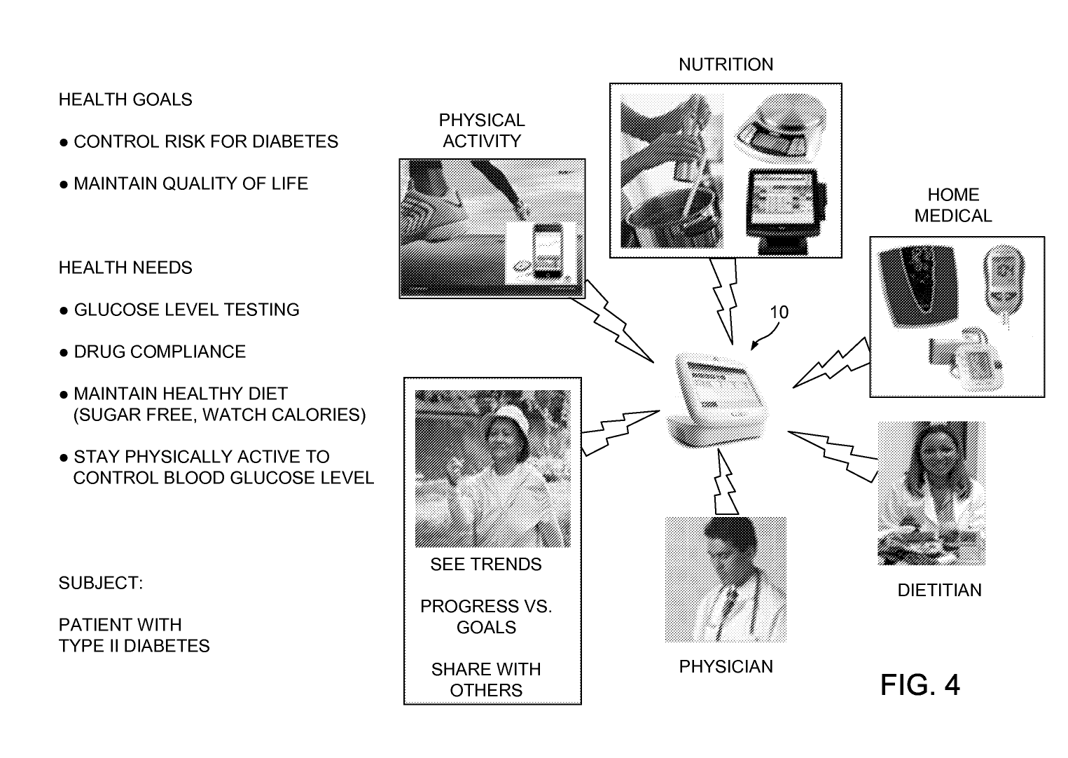

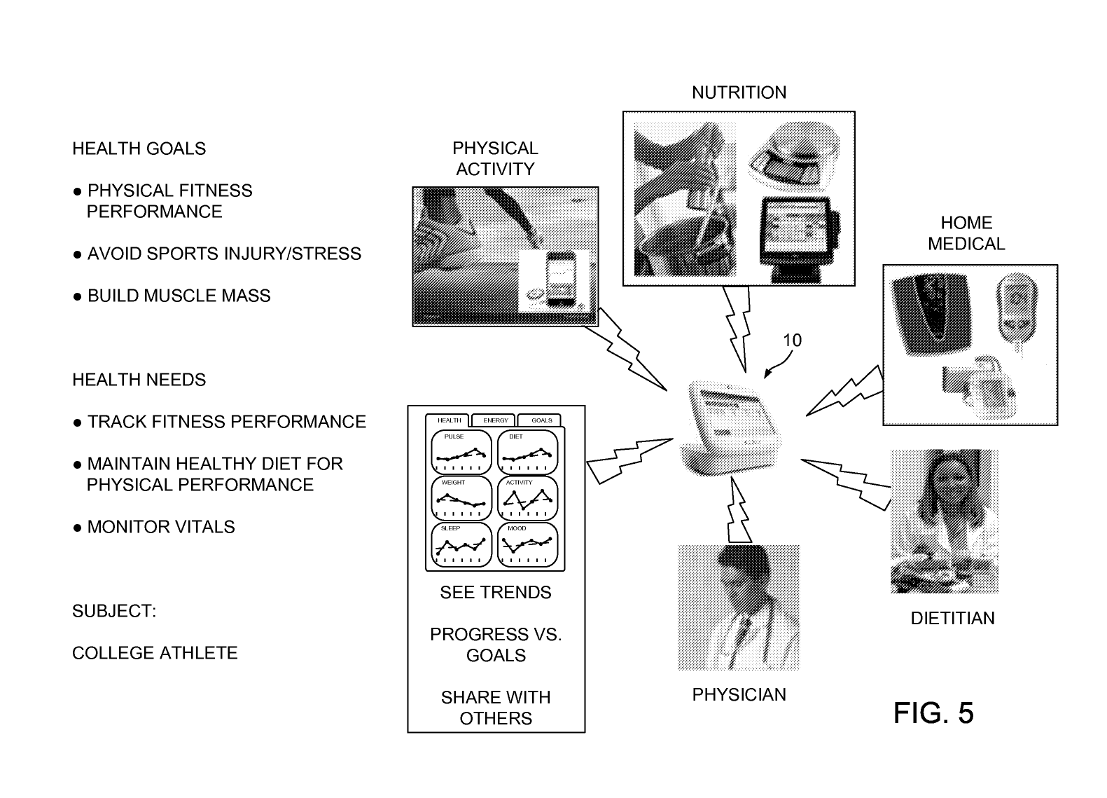

Examples of implementing health and wellness management system 10 and technique 44 for setting personalized health and wellness goals are shown in FIGS. 4 and 5. The health and wellness management system 10 provides for capturing, tracking, and managing health and wellness data to achieve the set health and wellness goals, as well as providing for receiving personalized guidance for achieving the health and wellness goals.

Referring first to FIG. 4, a first example is shown where health and wellness management system 10 is used by a consumer with type II diabetes. The consumer has health goals regarding keeping their diabetic condition under control and maintaining their quality of life. In order to achieve these goals, the consumer's key healthcare needs are related to medications compliance, glucose levels monitoring, healthy diet (e.g., sugar free diet, caloric intake), and physical activity.

To address these health goals and needs, medical professionals associated with the consumer suggest implementing devices including (1) medical/vitals monitoring devices, such as a glucose meter, scale, blood pressure measurement device etc., (2) fitness devices, such as a treadmill, elliptical, bike, or running monitoring device (e.g., ; the Nike iPhone® app for tracking running), and (3) devices or solutions for tracking nutritional data, such as a web-based nutritional tracking tool (e.g., www.foodcalc.com).

In operation, health and wellness management system 10 registers and enables the devices that the consumer will use for addressing their health goals. Thus, medical/vitals monitoring devices, fitness devices, and nutritional devices or solutions can be registered with health and wellness management system 10, such that data can be automatically transferred from these devices to the health and wellness management system 10. In addition to the automatic transfer of certain physiological, physical fitness, and nutritional data to the health and wellness management system 10 from enabled devices, it is also recognized that such data may be entered into health and wellness management system 10 manually by the consumer.

The receipt of physiological, physical fitness, and nutritional data by health and wellness management system 10 allows the consumer to efficiently track their performance with respect to nutrition uptake and physical activities as well as look at the impact of these on measured physiological parameters, such as weight, glucose levels and other health parameters relevant to keeping their diabetic condition under control and maintaining their quality of life. The acquired health data and the pre-set goals determined by the consumer are displayed to the consumer by way of a personalized healthcare dashboard generated by the health and wellness management system 10, as well as shared with other qualified health care professionals (e.g., physician, fitness trainer, and nutritionist) by way of summary reports sent to those individuals. The healthcare dashboard can integrate the acquired health data and the pre-set goals using time plots and other visualization means, thus allowing the consumer to track their progress in achieving the pre-set health goals of keeping their diabetic condition under control and maintaining their quality of life and in meeting the suggested levels for physical activity and dietary consumption.

In addition to tracking progress, the health and wellness management system 10 can also provided for updating the strategies that could help the consumer better manage their diabetes. That is, based on acquired physiological, physical fitness, and nutritional data, and a comparison of this data to recommended guidelines for these parameters provided by health and wellness management system 10, a health professional for the consumer (e.g., physician, fitness trainer, and nutritionist) may suggest changes or updates to the strategies and recommended guidelines/metrics for physical fitness activity, dietary consumption, medication levels, and so forth. The health professional would receive summary reports from health and wellness management system 10, via one of several secure mediums, that would provide the health professional with sufficient data to update the strategies and recommended guidelines regarding physical fitness and nutritional data for achieving the health goals for the consumer.

Referring now to FIG. 5, a second example is shown where health and wellness management system 10 is used by a college athlete. The athlete has health goals regarding maintaining and increasing their physical fitness performance, staying healthy by avoiding sports related injuries and extreme stress, and building muscle mass. In order to achieve these goals, the athlete's key health goal needs are related to track fitness performance, maintain appropriate diet to support physical performance, and overall health, and monitoring of vitals.

To address these health goals and needs, medical professionals associated with the athlete suggest implementing devices such as (1) medical/vitals monitoring devices, such as a scale, pulse-oxymetry device, heart rate monitor, body fat percentage tester etc., (2) fitness devices, such as a treadmill, elliptical, bike, or running monitoring device (e.g., ; the Nike iPhone app for tracking running), and (3) devices or solutions for tracking nutritional data, such as a web-based nutritional tracking tool (e.g., www.foodcalc.com) for tracking protein intake and overall caloric intake.

In operation, health and wellness management system 10 registers and enables devices that the athlete will use to address their health goals. Thus, medical/vitals monitoring devices, fitness devices, and nutritional devices or solutions can be registered with health and wellness management system 10, such that data can be automatically transferred from these devices to the health and wellness management system 10. In addition to the automatic transfer of certain physiological, physical fitness, and nutritional data to the health and wellness management system 10 from enabled devices, it is also recognized that such data may be entered into health and wellness management system 10 manually by the athlete or someone associated therewith (e.g., coach).

The receipt of physiological, physical fitness, and nutritional data by health and wellness management system 10 allows the athlete to efficiently track their performance with respect to nutrition uptake and physical activities as well as look at the impact of these on measured physiological parameters, such as weight, blood oxygen levels, maximum and resting heart rate, and body fat percentage. The acquired health data and the pre-set goals determined by the athlete are displayed to the athlete and shared with other qualified individuals (e.g., coach, fitness trainer, and nutritionist) by way of a personalized healthcare dashboard generated by the health and wellness management system 10. The healthcare dashboard can integrate the acquired health data and the pre-set goals using time plots and other visualization means, thus allowing the athlete to track their progress in achieving the pre-set health goals of increasing their physical fitness performance, staying healthy by avoiding sports related injuries and extreme stress, and building muscle mass, and in meeting the suggested levels for physical activity and dietary consumption.

In addition to tracking progress, the health and wellness management system 10 can also provided for updating the strategies that could help the athlete better achieve their athletic performance related goals. That is, based on acquired physiological, physical fitness, and nutritional data, and a comparison of this data to recommended guidelines for these parameters provided by health and wellness management system 10, an individual associated with the athlete, such as a coach, fitness trainer, and nutritionist, may suggest changes or updates to the strategies and recommended guidelines/metrics for physical fitness activity, nutritional uptake, and vitals such as weight, pulse, and sleep levels. The coach, fitness trainer, etc., would receive from health and wellness management system 10, via one of several secure mediums, access to the healthcare dashboard, for example, that would provide the individual with sufficient data to update the strategies and recommended guidelines regarding physical fitness and nutritional data for achieving the fitness performance and health goals for the athlete.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. Thus, a processor or series of modules including such instructions can be implemented according to the systems and methods described above for purposes of capturing, tracking, and managing health and wellness of a patient for achieving specified health goals.

A technical contribution for the disclosed method and apparatus is that is provides for a computer implemented system and method of capturing and tracking health and wellness data and of providing for home management of health and wellness via analysis and sharing of the data

Therefore, in accordance with one embodiment, a non-transitory computer readable storage medium has stored thereon a computer program comprising instructions, which, when executed by a computer, cause the computer to receive an input for generating a user profile for a user of interest, with the user profile having an initial health status goal associated therewith including target physiological parameter levels, nutritional uptake, and physical fitness activity. The instructions also cause the computer to receive physiological data, nutritional data, and physical fitness data for the user of interest over a period of time that are directed respectively to a plurality of measured physiological parameters, dietary consumption, and physical activity of the user of interest, and to analyze each of the physiological data, nutritional data, and physical fitness data. The instructions further cause the computer to compare each of the physiological data, nutritional data, and physical fitness data to the physiological parameters, nutritional uptake, and physical fitness activity associated with the initial health status goal and communicate to the user of interest a personalized health and wellness status update based on the analyzed physiological data, nutritional data, and physical fitness data, and on the comparison of such data to the physiological parameter levels, nutritional uptake, and physical fitness activity associated with the initial health status goal.

In accordance with another embodiment, a method for managing health and wellness for a user of interest includes the steps of generating a user profile for a user of interest on a health and wellness management system in response to a user input and establishing initial health and wellness goals for the user of interest and tied to the user profile, with the initial health and wellness goals having associated therewith target physiological parameter levels, nutritional uptake levels, and physical fitness activity levels. The method also includes the steps of acquiring and tracking physiological data, nutritional uptake data, and physical fitness activity data for the user of interest over a period of time by way of the health and wellness management system and analyzing each of the physiological data, nutritional uptake data, and physical fitness activity data using the health and wellness management system to determine at least one of: a trend in user health and wellness, compliance with the physiological parameter levels, nutritional uptake levels, and physical fitness activity levels associated with the initial health and wellness goals, and a correlation between the nutritional uptake levels, physical fitness activity levels, and acquired physiological data. The method further includes the step of communicating to the user of interest a personalized health and wellness status update based on the analysis of the physiological data, nutritional uptake data, and physical fitness activity data.

In accordance with yet another embodiment, a health and wellness management system includes a display screen configured to display health and wellness data to a user and a processor. The processor is programmed to formulate an initial health and wellness goal specific to a user of interest that includes target physiological parameter, nutritional uptake, and physical activity levels, automatically receive data on physiological parameters, dietary consumption, and physical activity for the user of interest from a plurality of enabled devices over a period of time, and analyze the data for each of the received physiological parameters, dietary consumption, and physical activity. The processor is further programmed to generate a personalized health dashboard on the display screen illustrative of the analyzed data on the physiological parameters, dietary consumption, and physical activity, with the personalized health dashboard displaying at least one of a trend chart of user physiological parameters, nutritional uptake, and physical activity levels, compliance with the initial health and wellness goal, and recommendations for the user of interest regarding nutritional uptake and physical fitness activity levels for meeting the initial health and wellness goal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A non-transitory computer readable storage medium having stored thereon a computer program comprising instructions, which, when executed by a computer, cause the computer to:
receive an input for generating a user profile for a user of interest, the user profile having an initial health status goal associated therewith including target physiological parameter levels, nutritional uptake, and physical fitness activity;
receive physiological data, nutritional data, and physical fitness data for the user of interest over a period of time, the physiological data, nutritional data, and physical fitness data being directed respectively to a plurality of measured physiological parameters, dietary consumption, and physical activity of the user of interest;
analyze each of the physiological data, nutritional data, and physical fitness data;
compare each of the physiological data, nutritional data, and physical fitness data to the physiological parameters, nutritional uptake, and physical fitness activity associated with the initial health status goal; and
communicate to the user of interest a personalized health and wellness status update based on the analyzed physiological data, nutritional data, and physical fitness data, and on the comparison of such data to the physiological parameter levels, nutritional uptake, and physical fitness activity associated with the initial health status goal.

2. The non-transitory computer readable storage medium of claim 1 wherein the instructions further cause the computer to:
set-up and manage profiles of third-party recipients associated with the user of interest;
generate summary reports directed to the physiological data, the nutritional data, and the physical fitness data received for the user of interest; and
share the summary reports with the third-party recipients by way of the profiles associated therewith.

3. The non-transitory computer readable storage medium of claim 2 wherein the instructions further cause the computer to share the summary reports with the third-party recipients by way of a secure encrypted data transmission.

4. The non-transitory computer readable storage medium of claim 2 wherein the instructions further cause the computer to:
receive feedback from the third-party recipients; and
update at least one of the target physiological parameter levels, nutritional uptake, and physical fitness activity level associated with the initial health status goal based on the third-party feedback.

5. The non-transitory computer readable storage medium of claim 1 wherein the instructions further cause the computer to:
register a plurality of enabled devices configured to acquire physiological data, nutritional data, and physical fitness data; and
automatically receive the physiological data, nutritional data, and physical fitness data from the plurality of enabled devices.

6. The non-transitory computer readable storage medium of claim 5 wherein the instructions further cause the computer to:
provide for registration of a plurality of users each having a user profile; and
authenticate physiological data, nutritional data, and physical fitness data received from the plurality of enabled devices as being from the user of interest, so as to distinguish the data received from the plurality of enabled devices as being from the user of interest or from one of the other plurality of users.

7. The non-transitory computer readable storage medium of claim 5 wherein the instructions further cause the computer to cause the enabled devices to transmit the physiological data, nutritional data, and physical fitness data in a common transmittable data format.

8. The non-transitory computer readable storage medium of claim 1 wherein the instructions further cause the computer to provide a visual health dashboard display to the user of interest of the physiological data, the nutritional data, and the physical fitness data, and the comparison of such data to the physiological parameter levels, nutritional uptake, and physical fitness activity associated with the initial health status goal, the visual health dashboard display including at least one of a graphical display, a textual display, and a numerical display.

9. The non-transitory computer readable storage medium of claim 8 wherein the instructions further cause the computer to:
analyze each of the physiological data, nutritional data, and physical fitness data to identify trends in each respective set of data; and
provide a graphical display on the visual health dashboard display illustrative of the received physiological data, nutritional data, and physical fitness data and of the trend in each respective set of data over time.

10. The non-transitory computer readable storage medium of claim 1 wherein the instructions further cause the computer to update the initial health status goal based on the comparison of the physiological data, nutritional data, and physical fitness data to the physiological parameters, nutritional uptake, and physical fitness activity associated with the initial health status goal.

11. The non-transitory computer readable storage medium of claim 10 wherein the instructions further cause the computer to:
correlate the received nutritional data and physical fitness data to the received physiological data; and
update at least one of the target nutritional uptake and target physical fitness activity level based on the correlation, so as to generate the updated health status goal.

12. The non-transitory computer readable storage medium of claim 1 wherein the instructions further cause the computer to generate an alert if a measured physiological parameter falls outside of a pre-determined threshold.

13. A method for managing health and wellness for a user of interest, the method comprising:
generating a user profile for a user of interest on a health and wellness management system in response to a user input;
establishing initial health and wellness goals for the user of interest and tied to the user profile, the initial health and wellness goals having associated therewith target physiological parameter levels, nutritional uptake levels, and physical fitness activity levels;
acquiring and tracking physiological data, nutritional uptake data, and physical fitness activity data for the user of interest over a period of time by way of the health and wellness management system;
analyzing each of the physiological data, nutritional uptake data, and physical fitness activity data using the health and wellness management system to determine at least one of: a trend in user health and wellness, compliance with the physiological parameter levels, nutritional uptake levels, and physical fitness activity levels associated with the initial health and wellness goals, and a correlation between the nutritional uptake levels, physical fitness activity levels, and acquired physiological data; and
communicating to the user of interest a personalized health and wellness status update based on the analysis of the physiological data, nutritional uptake data, and physical fitness activity data.

14. The method of claim 13 further comprising:
generating profiles of third-party recipients associated with the user of interest on the health and wellness management system;
generating summary reports directed to the physiological data, nutritional uptake data, and physical fitness activity data for the user of interest; and
sharing the summary reports with the third-party recipients by way of the profiles associated therewith.

15. The method of claim 14 further comprising:
receiving feedback from the third-party recipients; and
updating at least one of the target physiological parameter levels, nutritional uptake levels, and physical fitness activity levels associated with the initial health and wellness goals based on the third-party feedback.

16. The method of claim 13 wherein acquiring the physiological data, nutritional uptake data, and physical fitness activity data comprises:
registering a plurality of enabled devices with the health and wellness management system that are configured to acquire the physiological data, nutritional uptake data, and physical fitness activity data; and
automatically receiving the physiological data, nutritional uptake data, and physical fitness activity data from the plurality of enabled devices, the data received from the plurality of enabled devices having an authentication tag embedded therein to verify the data was acquired from the user of interest.

17. The method of claim 13 wherein communicating the personalized health and wellness status update to the user of interest comprises displaying to the user of interest a personalized health dashboard having at least one of a graphical display, a textual display, and a numerical display illustrative of the analyzed physiological data, nutritional uptake data, and physical fitness activity data, and that provides recommendations for the user of interest regarding nutritional uptake and physical fitness activity levels for meeting the initial health and wellness goals.

18. The method of claim 17 wherein displaying the personalized health dashboard comprises:
displaying a plurality of time plots of received physiological data, nutritional uptake data, and physical fitness activity data;
displaying a trend line for each of the plurality of time plots to illustrate a trend for each of a plurality of specified physiological parameters, nutritional uptake, and physical fitness activity.

19. A health and wellness management system comprising:
a display screen configured to display health and wellness data to a user; and
a processor programmed to:
formulate an initial health and wellness goal specific to a user of interest that includes target physiological parameter, nutritional uptake, and physical activity levels;
automatically receive data on physiological parameters, dietary consumption, and physical activity for the user of interest from a plurality of enabled devices over a period of time;
analyze the data for each of the received physiological parameters, dietary consumption, and physical activity; and
generate a personalized health dashboard on the display screen illustrative of the analyzed data on the physiological parameters, dietary consumption, and physical activity, the personalized health dashboard displaying at least one of a trend chart of user physiological parameters, nutritional uptake, and physical activity levels, compliance with the initial health and wellness goal, and recommendations for the user of interest regarding nutritional uptake and physical fitness activity levels for meeting the initial health and wellness goal.

20. The health and wellness management system of claim 19 wherein the processor is further programmed to:
generate summary reports directed to the received physiological parameters data, dietary consumption data, and physical activity data for the user of interest; and
transmit the summary reports to third-party recipients associated with the user of interest.

21. The health and wellness management system of claim 20 wherein the processor is further programmed to:
receive feedback from the third-party recipients; and
update at least one of the target physiological parameter levels, nutritional uptake levels, and physical fitness activity levels associated with the initial health and wellness goal based on the third-party feedback.

22. The health and wellness management system of claim 19 wherein the processor is further programmed to correlate the received dietary consumption data and the physical activity data with received physiological parameter data to determine a relationship therebetween.

23. The health and wellness management system of claim 19 wherein the processor is further programmed to:
compare the received physiological parameters data, dietary consumption data, and physical activity data to the target physiological parameter, nutritional uptake, and physical activity levels associated with the initial health and wellness goal; and
update the initial health and wellness goal based on the comparison of the received physiological parameters data, dietary consumption data, and physical activity data to the initial health and wellness goal.

24. The health and wellness management system of claim 19 wherein the processor is further programmed to authenticate the data received from the plurality of enabled devices as being acquired from the user of interest.
